(19) United States
(12) Patent Application Publication
(10) Pub. No.: US 2018/0260833 A1
(43) Pub. Date: Sep. 13, 2018

(54) METHODS AND SYSTEMS FOR DYNAMICALLY DISPLAYING VARIOUS FINANCIAL AND NON-FINANCIAL INCENTIVES TO DRIVE THE USE OF SELLERS' PREFERRED PAYMENT AND NON-PAYMENT OPTIONS AT THE TIME OF PERFORMING AN ELECTRONIC TRANSACTION

(71) Applicant: OMNYWAY, INC., Redwood City, CA (US)

(72) Inventors: Mohammad KHAN, San Jose, CA (US); Ashok NARASIMHAN, San Francisco, CA (US); William N. MELTON, San Francisco, CA (US)

(21) Appl. No.: 15/758,456

(22) PCT Filed: Sep. 8, 2016
(86) PCT No.: PCT/US2016/050800

§ 371 Date: Mar. 8, 2018

Related U.S. Application Data
(60) Provisional application No. 62/215,674, filed on Sep. 8, 2015.

(51) Int. Cl. G06Q 30/02; G06F 3/0484; G06Q 20/32; G06Q 30/06

(52) U.S. Cl. CPC G06Q 30/0222; G06F 3/04842; G06Q 30/0623; G06Q 20/3274; G06Q 20/3224

(57) ABSTRACT

Methods and systems for dynamically presenting various financial and non-financial incentives to drive the use of merchant-preferred payment and non-payment options at the time of performing an electronic transaction are provided. Prior to completion of the electronic transaction between a customer and a merchant, first and second sets of incentives associated with the electronic transaction are determined, the incentives being associated with respective payment or non-payment transaction options. First and second information, based on the first and second set of incentives, respectively, are determined and presented to the customer. The information may include incentives, undiscounted totals, and/or discounted totals. The order for displaying the information is dynamically determined. Upon selection of the information by the customer, the electronic transaction will be completed using the transaction option that is associated with the selected information.

### RELATED APPLICATIONS

This application claims the benefit of provisional application Ser. No. 62/215,674, filed Sep. 8, 2015, the disclosure of which is hereby incorporated herein by reference in its entirety.

### TECHNICAL FIELD

This disclosure relates to performing financial and non-financial electronic transactions at a physical point of sale or other location within a store (such as in an aisle or at a kiosk), at a virtual location such as a webpage or ecommerce site, and/or using a mobile device (e.g., using a mobile browser or other application.) More specifically, it relates to methods and systems for dynamically displaying various financial and non-financial incentives to drive a customer to use a seller's (merchant's) preferred payment and non-payment options at the time of performing an electronic transaction.

### BACKGROUND

Mobile devices are increasingly used to perform financial and non-financial electronic transactions. For example, mobile devices may be used to purchase items at physical point of sale locations (e.g., “brick and mortar” stores) or over the Internet, through or within a mobile application. Conventional mobile device user interfaces that are displayed during checkout, however, have not been updated to allow merchants to customize and incentivize customers to choose a merchant preferred payment option from among various methods of payment and/or to use loyalty merchant card in order to obtain discounts at the time of transaction. In addition, conventional mobile checkout interfaces typically provide the user with only one total amount for an order. This order total may or may not incorporate discounts applicable to the customer and/or the transaction, but does not allow the customer to select from among multiple checkout payment options to get the discounts. Conventional mobile checkout interfaces typically do not provide the customer with an option to view discounts applicable to the total transaction and/or to the individual items at the time of purchase. Finally, conventional mobile checkout interfaces typically do not allow customers to select best discount options, i.e., one or more of discounts related to loyalty points redemption, rewards, coupons, offers, product specific discounts, and other promotions, based on a selected merchant preferred payment option and/or also on using a merchant loyalty card from among one or more payment options a customer may have as part of the checkout process and immediately apply any associated discounts without restarting the checkout process. Moreover, conventional non-mobile checkout interfaces, especially in a physical store, also suffer the same limitations described above.

What is needed, therefore, is a way for merchants to customize the display of a customer mobile device and/or any other display facing the customer to dynamically display various financial and non-financial incentives to drive the use of merchant-preferred payment and non-payment options at the time of performing an electronic transaction. These methods and systems should allow a merchant to influence a customer's payment and non-payment options while allowing the customer to drill down and view various itemized discounts as well as discounts applied to a total amount.

### SUMMARY

The subject matter disclosed herein includes methods and systems for dynamically displaying various financial and non-financial incentives to drive the use of merchant-preferred payment and non-payment options at the time of performing an electronic transaction.

According to one aspect, a method for dynamically presenting various financial and non-financial incentives to drive the use of merchant-preferred payment and non-payment options at the time of performing an electronic transaction, comprises, at a time prior to completion of an electronic transaction between a customer and a merchant: determining a first set of incentives and a second set of incentives associated with the electronic transaction, wherein the first set of incentives is associated with a first transaction option and wherein the second set of incentives is associated with a second transaction option, wherein each transaction option comprises one or more payment or non-payment options, and determining, based on the first set of incentives, first information to be presented to the customer and determining, based on the second set of incentives, second information to be presented to the customer, the first and second information comprising at least one of: incentives, discounted totals, and undiscounted totals. The method further comprises dynamically determining an order for presenting the first and second information to the customer, and presenting the first and second information to the customer in the dynamically determined order for selection by the customer, wherein the electronic transaction will be completed using the transaction option associated with the information that is selected by the customer.

In one embodiment, the order is determined based at least in part on preferences provided by the merchant.

In one embodiment, at least one of the first set of incentives, the second set of incentives, the first information, and the second information is determined by a backend server.

In one embodiment, the first information and second information are presented to the customer by a backend server.

In one embodiment, at least one of the first set of incentives, the second set of incentives, the first information, and the second information is determined by a first backend server and transmitted to a second backend server and wherein the first and second information is transmitted from the second backend server to the customer.

In one embodiment, the first backend server is a merchant backend server that maintains merchant-centric information and wherein the second backend server is a mobile backend server that maintains customer-centric information.

In one embodiment, the first information and the second information are presented to the customer via a mobile device of the customer.

In one embodiment, the first information and the second information are presented to the customer via a device provided by the merchant.

In one embodiment, the method further comprises determining that the customer has selected one of the first and second information and completing the electronic transaction using the transaction option associated with the information that was selected by the customer.

In one embodiment, at least one of the first and second sets of incentives includes a discount based on a payment option used to complete the transaction.

In one embodiment, the payment option includes one of: a first party credit card, a third party credit card, a debit card, a coupon, and a gift card.

In one embodiment, at least one of the first and second sets of incentives includes a discount based on a loyalty card used to complete the transaction.

In one embodiment, at least one of the first and second sets of incentives includes a discount based on a promotion available to the customer based on personalized information associated with the customer.

In one embodiment, the personalized information includes a location of the customer.

In one embodiment, the location of the customer includes one of: a mall level, a merchant level, and an aisle level.

In one embodiment, the personalized information is received from a mobile device of the customer or from a point of sale terminal with which the customer interacts.

In one embodiment, at least one of the first and second sets of incentives includes a discount based on a loyalty level of the customer.

In one embodiment, at least one of the first and second sets of incentives includes a discount for each stock keeping unit (SKU) of individual products comprising the total.

In one embodiment, dynamically determining the order includes receiving an order determined by a merchant during checkout.

In one embodiment, at least one of the transaction options identifies a type of payment instrument to be used.

In one embodiment, the electronic transaction comprises a payment or non-payment transaction.

In one embodiment, the electronic transaction comprises at least one of: a payment or purchase; a credit transaction; a debit transaction; a prepaid transaction; a deposit; a withdrawal; a money transfer; a transaction involving a loyalty program; a transaction involving coupons, offers, or deals; a transaction involving marketing and sales promotions; a transaction involving a rewards program; and a transaction involving a diet, health, or fitness program.

In one embodiment, the electronic transaction comprises a mobile electronic transaction involving a mobile device of the customer.

In one embodiment, the mobile electronic transaction involves an interaction between the mobile device and a physical point of sale (POS) terminal or eCommerce site.

In one embodiment, the mobile device is digitally connected to the POS terminal or eCommerce site through the use of a quick response (QR) Code, a near field communication (NFC) connection, a Bluetooth or Bluetooth Low Energy (BLE) connection, WiFi, sound, numeric, or alphanumeric code that provides to the mobile device information that identifies the POS terminal or eCommerce site and which the mobile device uses to establish the digital connection to the POS terminal or eCommerce site.

In one embodiment, the mobile electronic transaction takes place within a physical store or outside of a physical store.

In one embodiment, the mobile device determines information about an item, a location, or a merchant through the use of a QR Code, an NFC connection, a Bluetooth or BLE connection, WiFi, sound, numeric, or alphanumeric code.

In one embodiment, the mobile device authenticates the user before allowing the transaction to be completed.

In one embodiment, the method further comprises, subsequent to selection by the customer and prior to completing the electronic transaction, at least one of: presenting the customer with additional options; requesting that the customer reconsider the customer's selection of a non-merchant-preferred payment or non-payment option; and rewarding the customer for selecting the merchant-preferred payment or non-payment option.

In one embodiment, presenting the customer with additional options includes presenting at least one of: an option to redeem rewards or loyalty points; an option to view one or more coupons; an option to take advantage of a discount or special offer; an option to apply and instantly receive a payment account; an option to apply and instantly receive a payment or non-payment digital card; an option to choose installment plan payment option; an option to perform an automated clearing house (ACH) transaction; additional products for the customer to consider; and alternatives to a product that the customer is about to purchase.

According to another aspect, a system for dynamically presenting various financial and non-financial incentives to drive the use of merchant-preferred payment and non-payment options at the time of performing an electronic transaction comprises a database for storing and maintaining user information, one or more processors, and memory storing instructions executable by the one or more processors. The system is operable to, at a time prior to completion of an electronic transaction between a customer and a merchant: determine a first set of incentives and a second set of incentives associated with the electronic transaction, wherein the first set of incentives is associated with a first transaction option and wherein the second set of incentives is associated with a second transaction option, wherein each transaction option comprises one or more payment and/or non-payment options; determine, based on the first set of incentives, first information to be presented to the customer and determining, based on the second set of incentives, second information to be presented to the customer, the first and second information comprising at least one of: incentives, discounted totals, and undiscounted totals; dynamically determine an order for presenting the first and second information to the customer; and present the first and second information to the customer in the dynamically determined order for selection by the customer, wherein the electronic transaction will be completed using the transaction option associated with the total information that is selected by the customer.

In one embodiment, the order is determined based at least in part on preferences provided by the merchant.

In one embodiment, at least one of the first set of incentives, the second set of incentives, the first information, and the second information is determined by a backend server.

In one embodiment, the first information and second information are presented to the customer by a backend server.

In one embodiment, at least one of the first set of incentives, the second set of incentives, the first information, and the second information is determined by a first backend server and transmitted to a second backend server and wherein the first and second information is transmitted from the second backend server to the customer.

In one embodiment, the first backend server is a merchant backend server that maintains merchant-centric information and wherein the second backend server is a mobile backend server that maintains customer-centric information.

In one embodiment, the first information and the second information are presented to the customer via a mobile device of the customer.

In one embodiment, the first information and the second information are presented to the customer via a device provided by the merchant.

In one embodiment, the system further comprises determining that the customer has selected one of the first and second information and completing the electronic transaction using the transaction option associated with the information that was selected by the customer.

In one embodiment, at least one of the first and second sets of incentives includes a discount based on a payment option used to complete the transaction.

In one embodiment, the payment option includes one of: a first party credit card, a third party credit card, a debit card, a coupon, and a gift card.

In one embodiment, at least one of the first and second sets of incentives includes a discount based on a loyalty card used to complete the transaction.

In one embodiment, at least one of the first and second sets of incentives includes a discount based on a promotion available to the customer based on personalized information associated with the customer.

In one embodiment, the personalized information includes a location of the customer.

In one embodiment, the location of the customer includes one of: a mall level, a merchant level, and an aisle level.

In one embodiment, the personalized information is received from a mobile device of the customer or from a point of sale terminal with which the customer interacts.

In one embodiment, at least one of the first and second sets of incentives includes a discount based on a loyalty level of the customer.

In one embodiment, at least one of the first and second sets of incentives includes a discount for each SKU of individual products comprising the total.

In one embodiment, dynamically determining the order includes receiving an order determined by a merchant during checkout.

In one embodiment, at least one of the transaction options identifies a type of payment instrument to be used.

In one embodiment, the electronic transaction comprises a payment or non-payment transaction.

In one embodiment, the electronic transaction comprises at least one of: a payment or purchase; a credit transaction; a debit transaction; a prepaid transaction; a deposit; a withdrawal; a money transfer; a transaction involving a loyalty program; a transaction involving coupons, offers, or deals; a transaction involving marketing and sales promotions; a transaction involving a rewards program; and a transaction involving a diet, health, or fitness program.

In one embodiment, the electronic transaction comprises a mobile electronic transaction involving a mobile device of the customer.

In one embodiment, the mobile electronic transaction involves an interaction between the mobile device and a physical POS terminal or eCommerce site.

In one embodiment, the mobile device is digitally connected to the POS terminal or eCommerce site through the use of a QR Code, an NFC connection, a Bluetooth or BLE connection, WiFi, sound, numeric, or alphanumeric code that provides to the mobile device information that identifies the POS terminal or eCommerce site and which the mobile device uses to establish the digital connection to the POS terminal or eCommerce site.

In one embodiment, the mobile electronic transaction takes place within a physical store or outside of a physical store.

In one embodiment, the mobile device determines information about an item, a location, or a merchant through the use of a QR Code, an NFC connection, a Bluetooth or BLE connection, WiFi, sound, numeric, or alphanumeric code.

In one embodiment, the mobile device authenticates the user before allowing the transaction to be completed.

In one embodiment, subsequent to selection by the customer and prior to completing the electronic transaction, the system at least one of: presents the customer with additional options; requests that the customer reconsider the customer's selection of a non-merchant-preferred payment or non-payment option; and rewards the customer for selecting the merchant-preferred payment or non-payment option.

In one embodiment, presenting the customer with additional options includes presenting at least one of: an option to redeem rewards or loyalty points; an option to view one or more coupons; an option to take advantage of a discount or special offer; an option to apply and instantly receive a payment account; an option to apply and instantly receive a payment or non-payment digital card; an option to choose installment plan payment option; an option to perform an ACH transaction; additional products for the customer to consider; and alternatives to a product that the customer is about to purchase.

The subject matter described herein may be implemented in hardware, software, firmware, or any combination thereof. As such, the terms “function” or “module” as used herein refer to hardware, software, and/or firmware for implementing the feature being described.

In one exemplary implementation, the subject matter described herein may be implemented using a computer readable medium having stored thereon executable instructions that when executed by the processor of a computer control the computer to perform steps. Exemplary computer readable media suitable for implementing the subject matter described herein include disk memory devices, chip memory devices, programmable logic devices, application specific integrated circuits, and other non-transitory storage media. In one implementation, the computer readable medium may include a memory accessible by a processor of a computer or other like device. The memory may include instructions executable by the processor for implementing any of the methods described herein. In addition, a computer readable medium that implements the subject matter described herein may be located on a single device or computing platform or may be distributed across multiple physical devices and/or computing platforms.

### BRIEF DESCRIPTION OF THE DRAWINGS

Embodiments of the subject matter described herein will now be explained with reference to the accompanying drawings, wherein the like reference numerals represent like parts, of which:

FIG. 1 is a block diagram illustrating an exemplary system for dynamically displaying various financial and non-financial incentives to drive the use of merchant-preferred payment and non-payment options at the time of performing an electronic transaction according to an embodiment of the subject matter described herein;

FIG. 2 is a flow chart illustrating an exemplary process for dynamically displaying various financial and non-financial incentives to drive the use of merchant-preferred payment and non-payment options at the time of performing an electronic transaction according to another embodiment of the subject matter described herein;

FIGS. 3A, 3B, 3C, and 3D are screenshots illustrating exemplary mobile checkout interfaces for dynamically displaying various financial and non-financial incentives to drive the use of merchant-preferred payment and non-payment options at the time of performing an electronic transaction according to embodiments of the subject matter described herein;

FIG. 4 illustrates a block diagram of an exemplary system for dynamically displaying various financial and non-financial incentives to drive the use of merchant-preferred payment and non-payment options at the time of performing an electronic transaction according to another embodiment of the subject matter described herein; and

FIG. 5 illustrates a block diagram of an exemplary system for dynamically displaying various financial and non-financial incentives to drive the use of merchant-preferred payment and non-payment options at the time of performing an electronic transaction according to yet another embodiment of the subject matter described herein.

### DETAILED DESCRIPTION

Methods and systems for dynamically displaying various financial and non-financial incentives to drive the use of merchant-preferred payment and non-payment options (hereinafter referred to collectively as “transaction options”) at the time of performing an electronic transaction are provided herein. In contrast to conventional mobile payment systems that simply provide a single order total, the methods and system described herein provides a list of selectable checkout options (e.g., alternative order totals) which are dynamically determined and displayed during checkout based on merchant preferences. There are several advantages to the methods and systems described herein. For example, by highlighting a preferred checkout option from among multiple checkout options, the customer can conveniently receive discounts on purchases while the merchant can steer the customer to particular payment options, loyalty cards, and the like. Moreover, by calculating discounts on both individual items and order totals and allowing the customer to view both, merchants can incentivize customers to purchase particular items and/or to allow for more fine-grained discounts than providing discounts only for order totals as conventional systems do.

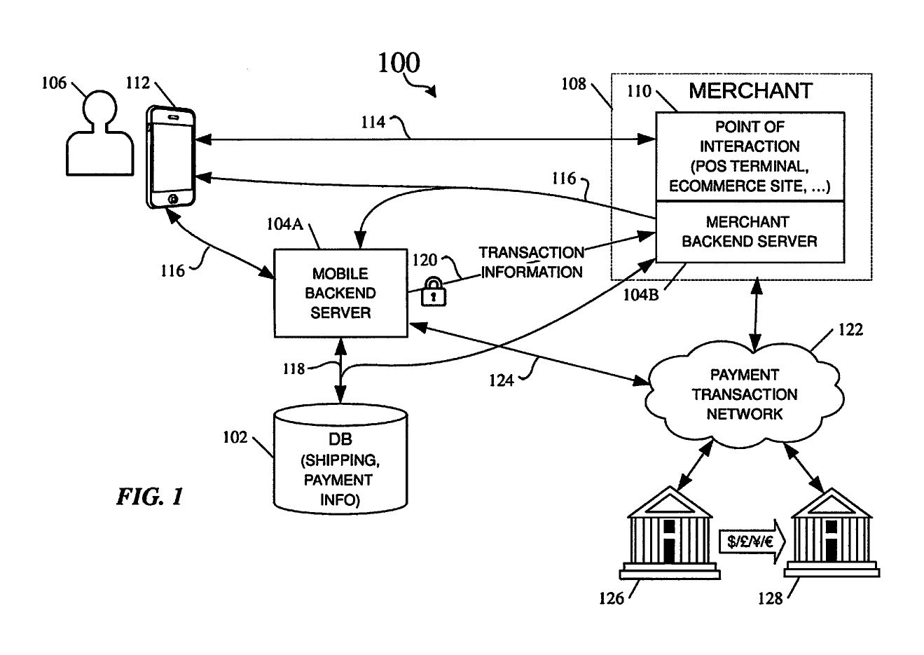

FIG. 1 is a block diagram illustrating an exemplary system for dynamically displaying various financial and non-financial incentives to drive the use of merchant-preferred payment and non-payment options at the time of performing an electronic transaction according to an embodiment of the subject matter described herein.

In the embodiment illustrated in FIG. 1, system 100 includes a database 102 for storing and maintaining user information. The system also includes a first processing module having hardware, and a second processing module having hardware. The first processing module dynamically determines, at a time prior to completion of an electronic transaction between a customer and a merchant, an order for displaying a first total and a second total associated with the electronic transaction. The first total is associated with a first transaction option having a first set of incentives and the second total is associated with a second transaction option having either no incentives or a second set of incentives different from the first set of incentives. Each transaction option comprises one or more payment and/or non-payment options. The second processing module presents the first total and the second total to the customer in the dynamically determined order for selection by the customer, receives as input information identifying the total that was selected by the customer, and, in response to receiving the input information, initiates completion of the electronic transaction using the transaction option associated with the total that was selected by the customer.

In one embodiment, the first and second processing modules are components of one or more backend servers. In the embodiment illustrated in FIG. 1, for example, the first and second processing modules may be components of a mobile backend server 104A, components of a merchant backend server 104B, or divided between them. As used herein, the term “backend server 104” signifies that a function or operation being discussed could happen at either mobile backend server 104A, merchant backend server 104B, at a third-party backend server (not shown), or some combination. Where a function or task is being performed by the mobile backend server 104A specifically or by the merchant backend server 104B specifically, the appropriate backend server will be specifically referenced.

FIG. 1 illustrates a scenario in which a customer 106 (also referred to herein as “user 106” and a merchant 108 are engaged in an electronic transaction. The electronic transaction may be a payment transaction or a non-payment transaction. Backend server 104 presents the first total and the second total to customer 106 in the dynamically determined order that is controlled by merchant 108. Backend server 104 receives as input information identifying the total that was selected by the customer, and initiates completion of the electronic transaction using the transaction option associated with the total that was selected by the customer. One or both of the first and second totals may be determined by backend server 104, by merchant 108, which then provides the information to backend server 104, or some combination of the above.

Where merchant 108 provides this information, it may come from a merchant point of interaction 110, such as a physical point of sale terminal, or a merchant backend server, such as an ecommerce website. Point of interaction 110 may also be, for example, a kiosk, a vending machine, a parking meter, or other entity with which user 106 may use his or her mobile device 112 to engage in an interaction 114, e.g., for the purpose of performing an electronic transaction.

Backend server 104 may present the first and second totals to the user in a number of different ways, including, but not limited to, as a visual display, as an aural communication, via a tactile or haptic device, etc. In one embodiment, information may be presented to user 106 via the merchant's device, such as a POS terminal 110.

In another embodiment, information may be presented to user 106 via the user's mobile device 112, which may be a cellphone, a laptop computer, a microphone and speaker, a haptic device, and so on. In the embodiment illustrated in FIG. 1, where there is both a mobile backend server 104A and a merchant backend server 104B, the information may be transmitted directly from merchant backend server 104B to mobile device 112, indirectly to mobile device 112 via mobile backend server 104A, or by some other path, e.g., from a third party backend server (not shown). These various paths are shown in FIG. 1 as communications paths 116.

User 106 then selects one of the presented totals. This selection may be detected by point of interaction 110, by mobile device 112, or other means. The user selection is conveyed to backend server 104, which initiates completion of the electronic transaction using the transaction option associated with the total that was selected by the customer.

The order in which the totals are presented to user 106 may be driven by a variety of factors. For example, the order may be based at least in part on preferences provided by the merchant. In one embodiment, the order may be based at least in part on the total amount (e.g., the totals may presented in order from lowest to highest.)

Any type of incentive may factor into the totals, including, but not limited to, discounts based on a payment option used to complete the transaction (e.g., the type of payment instrument, such as credit card, debit card, coupon, gift card, etc., as well as the card issuer), discounts based on a loyalty card used to complete the transaction, discounts based on a promotion available to the customer based on personalized information associated with the customer, such as the customer's location (e.g., country, state, county, area, within a shopping center, within a particular store, within a particular aisle in a store, within a store owned by a particular merchant, and so on), a discount based on a particular item or SKU included in the order, etc. The personalized user information may be provided by the merchant (e.g., by a POS, kiosk, or other entity within a physical store, or from an ecommerce server or other entity on a network), or by the user's mobile device.

In one embodiment, backend server 104 is configured to authenticate the user before completing the transaction. This authentication may be done with the help of mobile device 112 and/or point of interaction 110, e.g., by requiring the entry of a password, passcode, or passphrase, by fingerprint sensor or other biometric information, etc.

In one embodiment, database 102 may store customer-specific information, including, but not limited to, information that may pertain to an electronic transaction, such as loyalty card information, preferred payment information, discount information, etc. In one embodiment, mobile backend server 104A receives user information that identifies either user 106 directly (e.g., the user's name or other identifying information) or indirectly (e.g., by identifying mobile device 112 and using that information to identify the user of that mobile device.) Mobile backend server 104A may use this information to determine transaction information to be used to initiate an electronic transaction, e.g., by querying database 102 (communication 118). In one embodiment, mobile backend server 104A may send the transaction information to point of interaction 110 (communication 120), which initiates the transaction with a payment transaction network 122, for example, or mobile backend server 104A may send the transaction information directly to payment transaction network 122 (communication 124).

The electronic transaction may be a payment or non-payment transaction. Examples of electronic transactions include, but are not limited to, a payment or purchase, a credit transaction, a debit transaction, a prepaid transaction, a deposit, a withdrawal, a money transfer, a transaction involving a loyalty program, a transaction involving a rewards program, and a transaction involving a diet, health, or fitness program. An electronic transaction may involve the transfer of funds or other assets from one person, business entity, bank, or financial institution 126 to another person, business entity, bank or financial institution 128.

In one embodiment, user information may be stored in database 102 as part of a registration process. For example, the user of mobile device 112 may use an application within mobile device 112 to connect with mobile backend server 104A for the purpose of collecting the information that will be stored within database 102. In one embodiment, user 106 uses the application to enter credit card information, e.g., by manual entry, by taking an image of the card, by swiping the card using a magstripe reader attached to mobile device 112, or other means. The application communicates that information to mobile backend server. Alternatively, the user may use a secure web portal to enter that information using mobile device 112, a personal computer, etc. In one embodiment, the user may be asked to enter additional information to authorize the card data. Examples of authentication information include, but are not limited to, the CVV or CVC number commonly printed on the back of many credit or debit cards, user ID, password, passcode, or personal information number (PIN), fingerprint or other biometric information, and so on. This additional authentication information may or may not be stored within database 102, according to the rules and regulations as well as need for a particular kind of information.

In one embodiment, mobile backend server 104A may provide this authentication information along with transaction information 120. Other methods of populating database 102 are also within the subject matter described herein. The authentication information may be data that is used to perform the authentication (e.g., by mobile backend server 104A or another entity), an indication that the user was successfully authenticated, or both. In one embodiment, the fact that the authentication came from mobile device 112 (or from mobile backend server 104A, later) may be considered sufficient proof of authenticity.

For the sake of illustration of the concepts described herein, the example illustrated in FIG. 1 is an electronic payment transaction, but other electronic transactions, including both payment transactions and non-payment transactions, are also within the scope of the subject matter described herein. Examples of electronic transactions include, but are not limited to: a payment or purchase; a credit transaction; a debit transaction; a prepaid transaction; a deposit; a withdrawal; a money transfer; a transaction involving a loyalty program; a transaction involving a rewards program; and a transaction involving a diet, health, or fitness program. In one embodiment, the electronic transaction may be a payment transaction that is processed as a “card present” transaction. Likewise, the electronic transaction may be payment transaction that is processed as a “card not present” transaction. The methods and systems described herein may be applied to any electronic transaction where it is desirable to avoid transmission of sensitive data over a network as well as other forms of potential exposure to unauthorized entities.

At the time of payment during a transaction, user 106 is presented with multiple totals corresponding to different checkout options. In one scenario, one of the total amounts presented on the mobile device 106 includes a regular total that does not include any discounts or other incentives for using any particular payment options, loyalty card, or the like, and another total corresponds to an amount requested if the user does use a preferred payment option or loyalty card. Typically, the second, preferred amount is discounted (i.e., less than the regular amount) in order to incentivize the customer to select the preferred checkout option.

It may be appreciated that the ordering and manner of display of the different totals may vary based on merchant preferences and one or more factors. For example, a first merchant may wish to prioritize use of its loyalty card over use of any particular payment option. Conversely, a second merchant may wish to prioritize use of a particular payment option over a loyalty card. This may be because each merchant may have different business needs such as reducing payment processing costs, establishing customer relationships, or gathering shopping data on customers.

In additional embodiments, different order totals (and corresponding checkout options) may be associated with the entire order total (e.g., basket level) or with individual items within the order (e.g., SKU level). For example, in an embodiment where discounts are provided for individual items, the customer may be able to click on an order total to show each product and its individual discount. Thus, the discounts provided may be more personalized to the customer than conventional discount tags attached to physical store shelves.

The ordering and manner of displaying different order totals may also be driven by personalized information associated with the customer. Personalized information can include the loyalty level of the customer (e.g., gold, silver, platinum).

Personalized information can also include the location of the customer. For example, a GPS or other location mechanism associated with the mobile device 112 (e.g., Wi-Fi triangulation) may be used to determine a location of the customer at the time of purchase to varying levels of accuracy. The system 100 may determine, for example, a mall level, merchant level, or aisle level of the mobile device 112 and determine discounts accordingly. Additional methods for determining the location of the mobile device 112 can include use of a QR code. For example, the point of interaction 110 may display a QR code which is scanned by the mobile device 112 during checkout. In one embodiment, the QR code includes location information of the mobile device 112 (e.g., at a Shell gas station), which the mobile backend server 104 uses to determine that the mobile device 112 is located at a particular merchant. Information about the merchant and/or location could also be provided by other means such as Bluetooth or Bluetooth Low Energy (BLE) between the point of interaction 110 and the mobile device 112. The mobile backend server 104 could then determine, for example, that locations associated with that particular merchant (e.g., Shell stations) give a particular discount (e.g., 10 cent/per/gallon discount if you use a Shell loyalty card).

The preferred order and manner of displaying the totals during checkout may be established by each merchant and injected into the system 100 at the point of interaction 114.

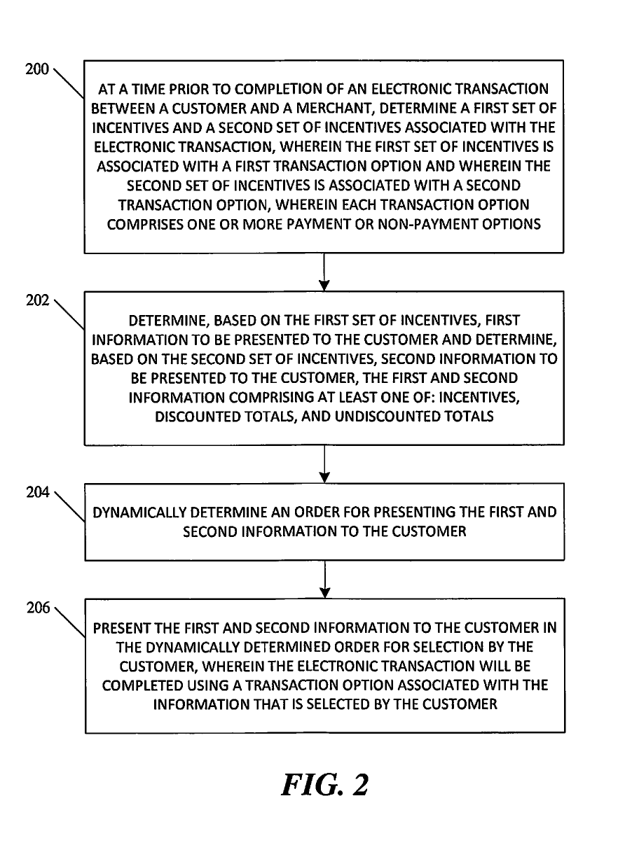

FIG. 2 is a flow chart illustrating an exemplary process for dynamically displaying various financial and non-financial incentives to drive the use of merchant-preferred payment and non-payment options at the time of performing an electronic transaction according to another embodiment of the subject matter described herein.

In the embodiment illustrated in FIG. 2, the process includes, at step 200, at a time prior to completion of the electronic transaction between a customer and a merchant, determining a first set of incentives and a second set of incentives associated with the electronic transaction, wherein the first set of incentives is associated with a first transaction option and wherein the second set of incentives is associated with a second transaction option, wherein each transaction option comprises one or more payment or non-payment options.

Step 202 includes determining, based on the first set of incentives, first information to be presented to the customer and determining, based on the second set of incentives, second information to be presented to the customer, the first and second information comprising at least one of: incentives, discounted totals, and undiscounted totals.

Step 204 includes dynamically determining an order for presenting the first and second information to the customer.

Step 206 includes presenting the first and second information to the customer in the dynamically determined order for selection by the customer, wherein the electronic transaction will be completed using a transaction option associated with the information that is selected by the customer.

It is appreciated that more than two sets of information can be determined corresponding to a variety of alternative checkout options. The ordering of the information so presented may be determined by the merchant at the time when payment it requested and provided to the customer's mobile device application via a cellular network, a point of sale terminal, an ecommerce website, or other means. The order may be determined based a number of factors. In one embodiment, the order is controlled by the merchant. In other embodiments, the order may be controlled based on input from the merchant and the user, based on input from the user alone, based on input from both merchant and user, based on input from some other entity, or some combination of the above.

The first information and the second information are selectable by the customer during checkout. For example, the information may include actual or predicted totals for items being purchased, in which case the least expensive option may be displayed first in a list of the totals. Alternatively or additionally, the second total may be highlighted or written in bold font in order to indicate a merchant preference for the second checkout option. It is also appreciated that because of the thumb position when holding a mobile device one handed, the most preferred location for displaying the second total in a list may be either at the top of the bottom of the list. The customer may then click on or otherwise select between the displayed alternative options and proceed to authorizing payment for the items according to the selected checkout options (e.g., discounts, payment method, and/or loyalty card). Once the customer makes a selection, the electronic transaction will be completed using the transaction option associated with the total that is selected by the customer.

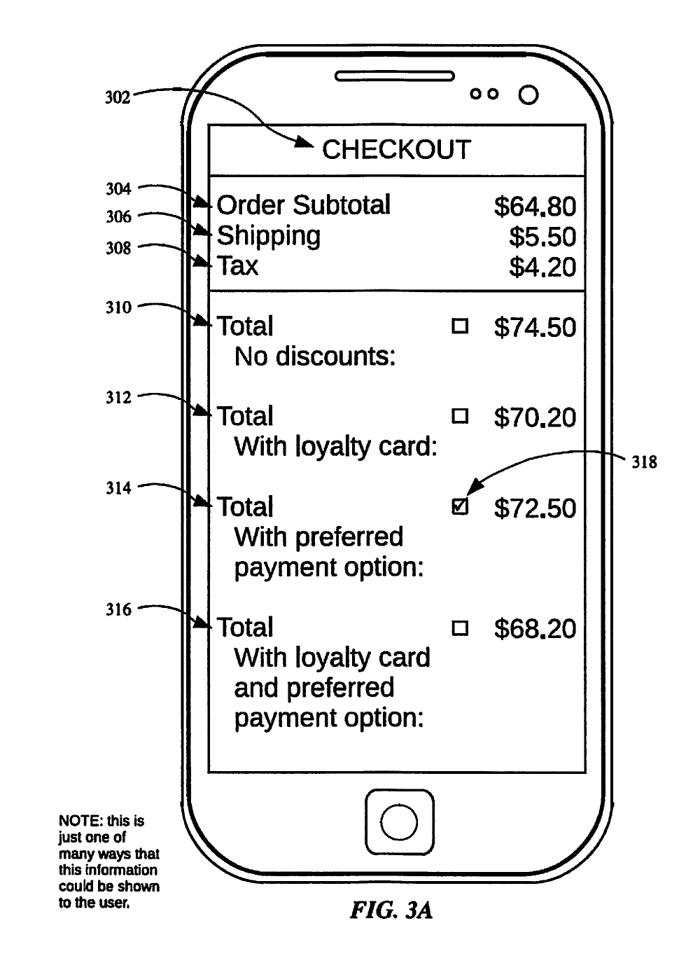

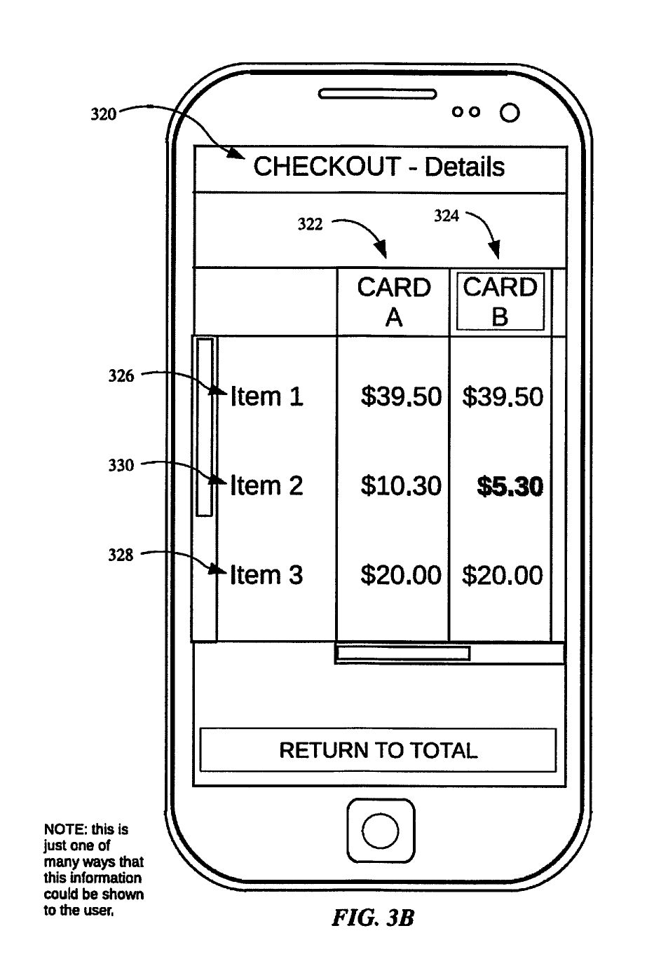

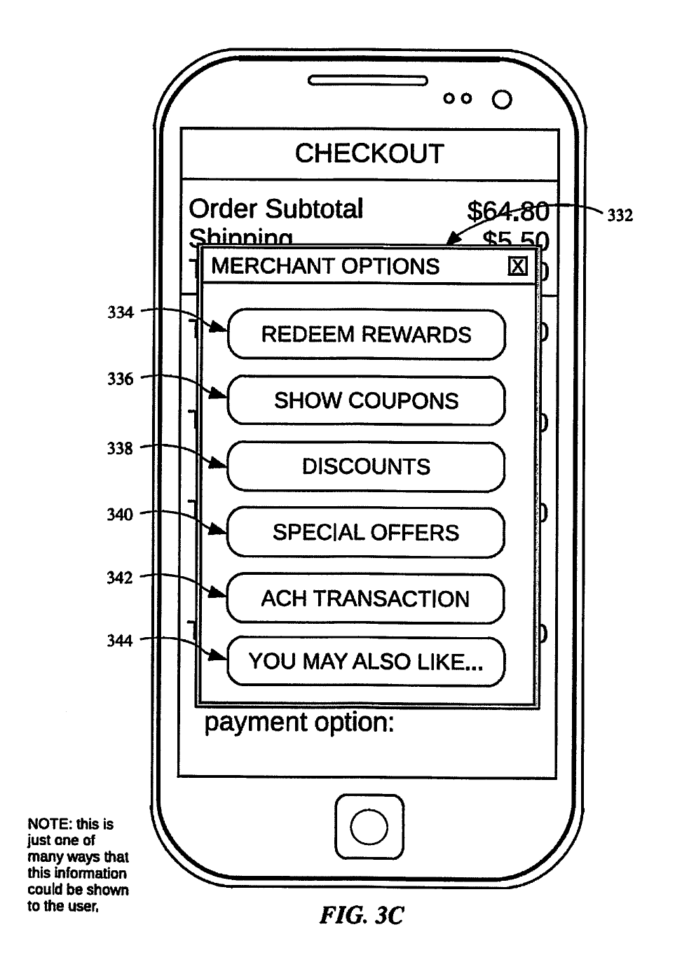

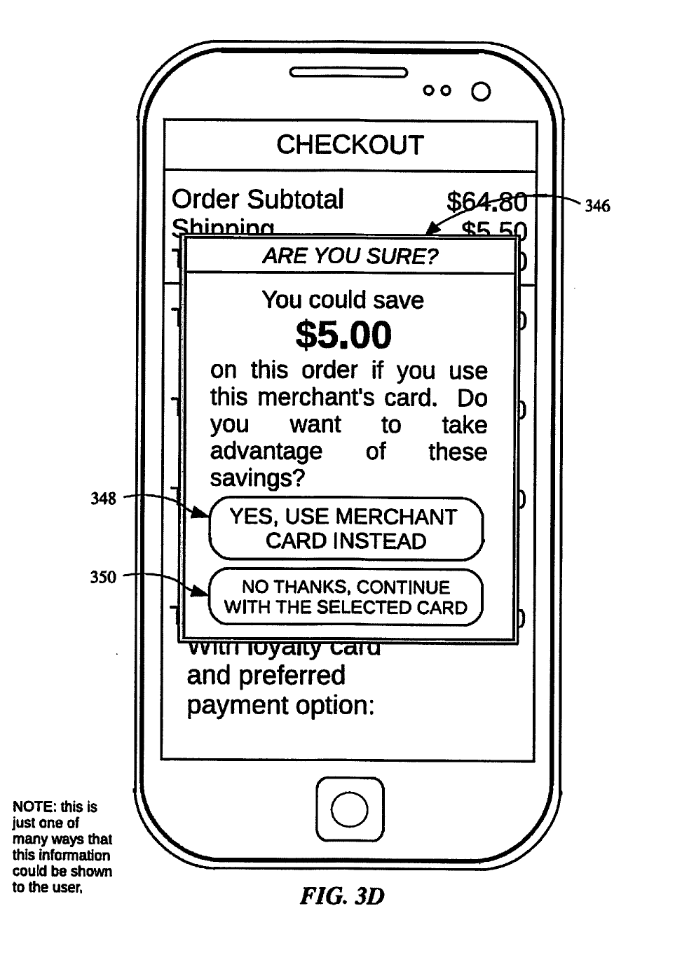

FIGS. 3A, 3B, and 3C are screenshots illustrating exemplary mobile checkout interfaces for dynamically displaying various financial and non-financial incentives to drive the use of merchant-preferred payment and non-payment options at the time of performing an electronic transaction according to an embodiment of the subject matter described herein.

FIG. 3A illustrates a display interface 302 that may be presented at a time when payment is requested during a mobile transaction. The checkout interface 302 may include an order subtotal amount 304, a shipping amount 306, and a tax amount 308, in addition to other suitable amounts (not shown) which may be components of the total payment amount requested. The order subtotal 304, shipping 306, and tax 308 may be summed together to determine an order total 310 that does not include any discounts. Thus, in the example shown, order total 310 may be $74.50 which is the sum of $64.80 (subtotal 304), $5.50 (shipping 306), and $4.20 (tax 308).

In addition to order total 310, alternative order totals 312, 314, and 316 may be presented to the user for comparison and selection. As described herein, discounts may be provided based on various factors including, but not limited to, use of a particular payment option (e.g., credit card, debit card), use of a particular loyalty card, use of a coupon, the location of the customer at the time of purchase, or other personal information of the customer. For example, order total 312 may offer a $4.30 discount from the regular total price of $74.50 if the customer uses a loyalty card. As will be described in greater detail with respect to FIG. 3C, the customer may be provided with an opportunity to choose from among multiple existing loyalty cards or to sign up for a new loyalty card as part of the checkout process in order to obtain the discount.

In another example, order total 314 may offer a discount of $2.00 from the regular total price of $74.50 if the customer uses a preferred payment option. This may typically include a particular debit or credit card preferred by the merchant, but may also include coupons, gift cards, or other various forms of payment. Lastly, order total 316 may combine the discounts from order totals 312 and 314 if the customer uses both a preferred payment option and a loyalty card. In the example shown, the customer may receive a discount of $6.30 off the regular order total, which is equal to the $4.30 discount for using a loyalty card and the $2.00 discount for using a preferred payment option. In the example shown, the customer has selected order total 314, as indicated by the checkmark in the box next to order total 314, thus indicating that that the customer wishes to use a preferred payment option and receive the corresponding discount.

The number of alternative order totals that may be presented to the customer are not limited to the order totals 310-316 shown in FIG. 3A. Moreover, the amount of the discount associated with order total 316 may also be greater or less than the sum of discounts 312 and 314. For example, use of both a loyalty card and a preferred payment option may provide an additional ‘synergy’ discount in order to encourage customers to use certain combinations of loyalty cards and payment options preferred by the merchant.

Additionally, the order in which order totals 310-316 are displayed may be determined by the merchant. In the illustration shown in FIG. 3A, the most preferred option 316 is displayed at the bottom in order to be nearest to the customer's typical thumb position when holding the mobile device. The second most preferred option 314 is displayed second from the bottom. It may be noted that while option 314 is the second most preferred by the merchant, it is not the second least expensive option. In the example shown, the merchant may prefer that the customer use a preferred payment option more than for the customer to use a loyalty card. In other possible embodiments (not shown), however, it is appreciated that the order totals 310-316 may be ordered differently, including from least expensive to most expensive (i.e., from most discounted to least discounted). In the embodiment illustrated in FIG. 3A, the checkbox 318 indicates that the user has elected to use the preferred payment option without the loyalty card.

FIG. 3B illustrates a display interface 302 that may be presented at a time when payment is requested during a mobile transaction according to an embodiment of the subject matter described herein. The Checkout—Details screen 320 may display the individual items that comprise the customer's shopping cart that corresponds with the order subtotal 304 on main checkout screen 302. Checkout—Details screen 320 may include multiple columns. In the embodiment illustrated in FIG. 3B, for example, the user can see the prices of the items if the user selects “Card A” (column 322) versus the prices of the items if the user selects “Card B” (column 324). In this example, column 324 highlights items that have a lower cost in bold so that the user can easily see the discounted price that would be available if the user selects the merchant-preferred Card B. In the example shown, Item 1 326 has a regular price of $39.50 and does not offer a discounted price (i.e., the price in column 324 is the same as in column 322). Similarly, Item 3 328 has a regular price of $20.00 and does not offer a discounted price. Item 2 330, however, has a regular price of $7.30 and a discounted price of $5.30. Because the customer selected to use a preferred payment option, the customer received a discount of $5.00 on item 2 326 bringing its price down to $5.30. In alternative embodiments, FIG. 3B may also display the sum of all items in the list, the sum of the discounts provided based on the selected card, or other information that may provide an incentive to the user to use the merchant-preferred payment instrument.

FIG. 3C illustrates a display interface 332 that may be presented at a time when payment is requested during a mobile transaction according to an embodiment of the subject matter described herein. In the embodiment illustrated in FIG. 3C, the customer may be presented with a choice of options, which may include but are not limited to the following:
The option to redeem loyalty rewards, points, frequent flier miles, etc., and apply the redeemed value to the current transaction (button 334).
The option to have displayed to the user a list of coupons that may be used at the time of checkout (button 336). The list may include coupons that are pertinent to the items about to be purchased, pertinent to the user based on previous purchasing history, etc.
The option to take advantage of discounts made available to the user (button 338). For example, a merchant may offer a merchant-provided or manufacturer-provided discount.
The option to have displayed a list of special offers (button 340).
The option to make other types of payments or payment using an option that was not selected by the user at that point (button 342), such as performing an ACH transaction.
The option to see other items that may be of interest to the user (button 344). This provides the merchant with the opportunity to “upsell”, e.g., to encourage the user to consider purchasing a better, more expensive, or otherwise better-suited item instead of—or in addition to—an item in the checkout list.
An option to apply and instantly receive a payment account.
An option to apply and instantly receive a payment or non-payment digital card.
An option to choose an installment plan payment option.

All of the options described above (e.g., coupons, discounts, special offers, and so on) may be tailored to a specific user, based on the user's identity, location, purchasing history, membership in rewards clubs, or any other factor. Likewise, the list of items shown—or the options presented if the user presses one of the buttons—may change based on the user's current selection of payment type.

FIG. 3D illustrates a display interface 346 that may be presented at a time when payment is requested during a mobile transaction according to an embodiment of the subject matter described herein. FIG. 3D illustrates the point that, should the customer select a payment option that is not preferred by the merchant, the merchant may still have an opportunity to change the user's mind and encourage them to select the merchant-preferred option. In the embodiment illustrated in FIG. 3D, a user who has not selected the merchant-preferred option is notified of the additional savings that could be had if the user had gone with the merchant-preferred option, and given the opportunity to use the merchant-preferred option (button 348) or to continue with their selection even though it is not the merchant-preferred option (button 350).

The embodiments illustrated in FIGS. 3A, 3B, 3C, and 3D are intended to be illustrative and not limiting. The subject matter described herein contemplates allowing a merchant to use any number of techniques to encourage the user to select the card or payment instrument preferred by the merchant. For example, the price paid by the user who uses the merchant-preferred payment instrument (hereinafter referred to as the “discounted price”) versus the price paid by the user who does not use the merchant-preferred payment instrument (hereinafter referred to as the “regular price”) may be presented to the user in any number of ways. In one embodiment, the two prices may be presented side by side, arranged vertically, horizontally, above or below, or other visual relationship. In another embodiment, the regular price may be presented as a list and the discounted price may be presented as a list of discounts, such as “$3.00 off”, or “15% off”, etc. Likewise, the discounted price may be listed and the regular price shown as how much extra it would cost the user if the merchant-preferred payment instrument is not used. In another embodiment, the user may toggle between displaying the regular price and the discounted price, e.g., the user sees one or the other but not both at the same time. In yet another embodiment, the user may touch a number displayed on the screen to trigger a pop-up window that shows how that value would change depending on whether or not the merchant-preferred instrument was used. As seen in FIGS. 3A and 3B, multiple variations (e.g., with or without merchant-preferred card, with or without merchant loyalty or rewards program, and so on) may be displayed simultaneously or in multiple combinations.

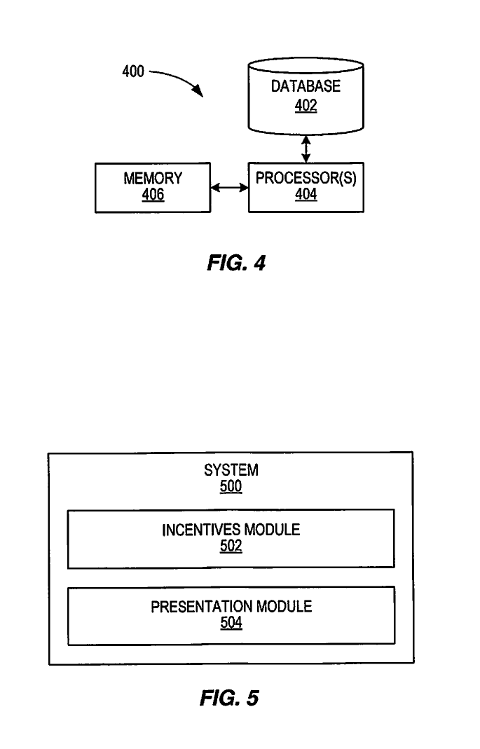

FIG. 4 illustrates a block diagram of an exemplary system for dynamically displaying various financial and non-financial incentives to drive the use of merchant-preferred payment and non-payment options at the time of performing an electronic transaction according to another embodiment of the subject matter described herein. In the embodiment illustrated in FIG. 4, system 400 comprises a database 402 for storing and maintaining user information, one or more processors 404, and memory 406 storing instructions executable by the one or more processors 404. The system is operable to, at a time prior to completion of an electronic transaction between a customer and a merchant: determine a first set of incentives and a second set of incentives associated with the electronic transaction, wherein the first set of incentives is associated with a first transaction option and wherein the second set of incentives is associated with a second transaction option, wherein each transaction option comprises one or more payment and/or non-payment options; determine, based on the first set of incentives, first information to be presented to the customer and determining, based on the second set of incentives, second information to be presented to the customer, the first and second information comprising at least one of: incentives, discounted totals, and undiscounted totals; dynamically determine an order for presenting the first and second information to the customer; and present the first and second information to the customer in the dynamically determined order for selection by the customer, wherein the electronic transaction will be completed using the transaction option associated with the total information that is selected by the customer.

FIG. 5 illustrates a block diagram of an exemplary system for dynamically displaying various financial and non-financial incentives to drive the use of merchant-preferred payment and non-payment options at the time of performing an electronic transaction according to yet another embodiment of the subject matter described herein. In the embodiment illustrated in FIG. 5, system 500 comprises an incentives module 502 and a presentation module 504.

The incentives module 502 determines, at a time prior to completion of an electronic transaction between a customer and a merchant, a first set of incentives and a second set of incentives associated with the electronic transaction, wherein the first set of incentives is associated with a first transaction option and wherein the second set of incentives is associated with a second transaction option, wherein each transaction option comprises one or more payment or non-payment options.

The presentation module 504 determines, based on the first set of incentives, first information to be presented to the customer and determining, based on the second set of incentives, second information to be presented to the customer, the first and second information comprising at least one of: incentives, discounted totals, and undiscounted totals, for dynamically determining an order for presenting the first and second information to the customer. The presentation module 504 presents the first and second information to the customer in the dynamically determined order for selection by the customer, wherein the electronic transaction will be completed using the transaction option associated with the information that is selected by the customer.

The example embodiments described herein are intended to be illustrative and not limiting. It is important to note that the order of the actions and messages described above are for illustration only and are not intended to be limiting. Furthermore, embodiments having additional steps or fewer steps are also within the scope of the subject matter described herein.

Embodiment 1: A method for dynamically presenting various financial and non-financial incentives to drive the use of merchant-preferred payment and non-payment options at the time of performing an electronic transaction, the method comprising: at a time prior to completion of an electronic transaction between a customer and a merchant: determining a first total and a second total associated with the electronic transaction, wherein the first total is associated with a first transaction option having a first set of incentives and wherein the second total is associated with a second transaction option having either no incentives or a second set of incentives different from the first set of incentives, wherein each transaction option comprises one or more payment and/or non-payment options; dynamically determining, by a backend server, an order for presenting the first total and the second total to the customer; and presenting the first total and the second total to the customer in the dynamically determined order for selection by the customer, wherein the electronic transaction will be completed using the transaction option associated with the total that is selected by the customer.

Embodiment 2: The method of embodiment 1 wherein at least one of the first and second totals is determined by the backend server.

Embodiment 3: The method of embodiment 1 wherein the first and second totals are presented to the customer by the backend server.

Embodiment 4: The method of embodiment 1 wherein at least one of the first and second totals is determined by a first backend server, which transmits the totals to a second backend server, and wherein the first and second totals are presented to the customer by the second backend server.

Embodiment 5: The method of embodiment 4 wherein the first backend server is a merchant backend server that maintains merchant-centric information and wherein the second backend server is a mobile backend server that maintains customer-centric information.

Embodiment 6: The method of embodiment 4 wherein at least one of the first and second backend servers is a third-party backend server not controlled by the merchant.

Embodiment 7: The method of embodiment 1 wherein presenting the first and second totals to the customer includes presenting the first and second totals to the customer via a visual, aural, or tactile display method.

Embodiment 8: The method of embodiment 1 wherein the first and second totals are presented to the customer via the customer's mobile device.

Embodiment 9: The method of embodiment 1 wherein the first and second totals are presented to the customer via a device provided by the merchant.

Embodiment 10: The method of embodiment 1 comprising determining that the customer has selected a total and completing the electronic transaction using the transaction option associated with the total that was selected by the customer.

Embodiment 11: The method of embodiment 1 wherein the order is determined based at least in part on preferences provided by a merchant.

Embodiment 12: The method of embodiment 1 wherein the order is determined based at least in part on the first and second totals.

Embodiment 13: The method of embodiment 1 wherein the order is determined from a lowest total to a highest total.

Embodiment 14: The method of embodiment 1 wherein at least one of the first and second sets of incentives includes a discount based on a payment option used to complete the transaction.

Embodiment 15: The method of embodiment 14 wherein the payment option includes one of: a first party credit card, a third party credit card, a debit card, a coupon, and a gift card.

Embodiment 16: The method of embodiment 1 wherein at least one of the first and second sets of incentives includes a discount based on a loyalty card used to complete the transaction.

Embodiment 17: The method of embodiment 1 wherein at least one of the first and second sets of incentives includes a discount based on a promotion available to the customer based on personalized information associated with the customer.

Embodiment 18: The method of embodiment 17 wherein the personalized information includes a location of the customer.

Embodiment 19: The method of embodiment 18 wherein the location of the customer includes one of: a mall level, a merchant level, and an aisle level.

Embodiment 20: The method of embodiment 17 wherein the personalized information is received from a mobile device of the customer or from a point of sale terminal with which the customer interacts.

Embodiment 21: The method of embodiment 1 wherein at least one of the first and second sets of incentives includes a discount based on a loyalty level of the customer.

Embodiment 22: The method of embodiment 1 wherein at least one of the first and second sets of incentives includes a discount for each stock keeping unit (SKU) of individual products comprising the total.

Embodiment 23: The method of embodiment 1 wherein dynamically determining the order includes receiving an order determined by a merchant during checkout.

Embodiment 24: The method of embodiment 1 wherein at least one of the transaction options identifies a type of payment instrument to be used.

Embodiment 25: The method of embodiment 1 wherein the electronic transaction comprises a payment or non-payment transaction.

Embodiment 26: The method of embodiment 1 wherein the electronic transaction comprises at least one of: a payment or purchase; a credit transaction; a debit transaction; a prepaid transaction; a deposit; a withdrawal; a money transfer; a transaction involving a loyalty program; a transaction involving coupons, offers, or deals; a transaction involving marketing and sales promotions; a transaction involving a rewards program; and a transaction involving a diet, health, or fitness program.

Embodiment 27: The method of embodiment 1 wherein the electronic transaction comprises a mobile electronic transaction involving a mobile device of the customer.

Embodiment 28: The method of embodiment 27 wherein the mobile electronic transaction involves an interaction between the mobile device and a physical point of sale (POS) terminal.

Embodiment 29: The method of embodiment 28 wherein the POS terminal is digitally connected to the mobile device through the use of a QR Code, an NFC connection, a Bluetooth or Bluetooth Low Energy (BLE) connection, WiFi, sound, numeric, or alphanumeric code.

Embodiment 30: The method of embodiment 27 wherein the mobile electronic transaction takes place within a physical store or outside of a physical store.

Embodiment 31: The method of embodiment 27 wherein the mobile device determines information about an item, a location, or a merchant through the use of a QR Code, an NFC connection, a Bluetooth or BLE connection, WiFi, sound, numeric, or alphanumeric code.

Embodiment 32: The method of embodiment 27 where the mobile electronic transaction take place at an eCommerce site on a PC, tablet, or portable computing device that digitally connects to an eCommerce session through the use of a QR Code, an NFC connection, a Bluetooth or BLE connection, WiFi, sound, numeric, or alphanumeric code.

Embodiment 33: The method of embodiment 27 wherein the mobile device authenticates the user before allowing the transaction to be completed.

Embodiment 34: The method of embodiment 1 comprising, subsequent to selection by the customer and prior to completing the electronic transaction, at least one of: presenting the customer with additional options; requesting that the customer reconsider the customer's selection of a non-merchant-preferred payment or non-payment option; and rewarding the customer for selecting the merchant-preferred payment or non-payment option.

Embodiment 35: The method of embodiment 34 wherein presenting the customer with additional options includes presenting at least one of: an option to redeem rewards or loyalty points; an option to view one or more coupons; an option to take advantage of a discount or special offer; an option to perform an ACH transaction; additional products for the customer to consider; and alternatives to a product that the customer is about to purchase.

Embodiment 36: A system for dynamically presenting various financial and non-financial incentives to drive the use of merchant-preferred payment and non-payment options at the time of performing an electronic transaction, the system comprising: a database for storing and maintaining user information; and a first processing module having hardware and that dynamically determines, at a time prior to completion of an electronic transaction between a customer and a merchant, an order for displaying a first total and a second total associated with the electronic transaction, wherein the first total is associated with a first transaction option having a first set of incentives and wherein the second total is associated with a second transaction option having either no incentives or a second set of incentives different from the first set of incentives, wherein each transaction option comprises one or more payment and/or non-payment options; a second processing module having hardware and that presents the first total and the second total to the customer in the dynamically determined order for selection by the customer, receives as input information identifying the total that was selected by the customer, and, in response to receiving the input information, initiates completion of the electronic transaction using the transaction option associated with the total that was selected by the customer.

Embodiment 37: The system of embodiment 36 wherein at least one of the first and second totals is determined by the first processing module.

Embodiment 38: The system of embodiment 36 wherein the first processing module is separate and distinct from the second processing module.

Embodiment 39: The system of embodiment 36 wherein the first and second processing modules are co-located and/or share processing hardware.

Embodiment 40: The system of embodiment 36 wherein at least one of the first and second totals is determined by the merchant and provided to the first processing module.

Embodiment 41: The system of embodiment 36 wherein the least one of the first and second totals is provided to the first processing module from a merchant point of interaction or backend server.

Embodiment 42: The system of embodiment 36 wherein the second processing module presents the first and second totals to the customer via a visual, aural, or tactile display method.

Embodiment 43: The system of embodiment 36 wherein the first processing module determines the order based at least in part on preferences provided by the merchant.

Embodiment 44: The system of embodiment 36 wherein the first processing module determines the order based at least in part on the first and second totals.

Embodiment 45: The system of embodiment 36 wherein the first processing module determines the order from a lowest total to a highest total.

Embodiment 46: The system of embodiment 36 wherein the second processing module presents the first and second totals to the customer via the customer's mobile device.

Embodiment 47: The system of embodiment 36 the second processing module presents the first and second totals to the customer via a device provided by the merchant.

Embodiment 48: The system of embodiment 36 wherein the database stores at least one of: loyalty card information, preferred payment information, and discount information.

Embodiment 49: The system of embodiment 36 wherein at least one of the first processing module and the second processing module receives user information that identifies a user of a mobile device, uses the user information to determine transaction information to be used to initiate an electronic transaction, and sends the transaction information to a point of interaction, distinct from the mobile device, for initiating the electronic transaction

Embodiment 50: The system of embodiment 36 wherein at least one of the first and second sets of incentives includes a discount based on a payment option used to complete the transaction.

Embodiment 51: The system of embodiment 50 wherein the payment option identifies a type of payment instrument to be used.

Embodiment 52: The system of embodiment 50 wherein the payment option includes one of: a first party credit card, a third party credit card, a debit card, a coupon, and a gift card.

Embodiment 53: The system of embodiment 36 wherein at least one of the first and second sets of incentives includes a discount based on a loyalty card used to complete the transaction.

Embodiment 54: The system of embodiment 36 wherein at least one of the first and second sets of incentives includes a discount based on a promotion available to the customer based on personalized information associated with the customer.

Embodiment 55: The system of embodiment 54 wherein the personalized information includes a location of the customer.

Embodiment 56: The system of embodiment 55 wherein the location of the customer includes one of: a mall level, a merchant level, and an aisle level.

Embodiment 57: The system of embodiment 36 wherein at least one of the first and second sets of incentives includes a discount based on a loyalty level of the customer.

Embodiment 58: The system of embodiment 36 wherein at least one of the first and second sets of incentives includes a discount for each SKU of individual products comprising the total.

Embodiment 59: The system of embodiment 36 wherein at least one of the first processing module and the second processing module is configured to receive user information from the mobile device via a point of sale terminal.

Embodiment 60: The system of embodiment 36 wherein at least one of the first processing module and the second processing module is further configured to authenticate the user before completing checkout.

Embodiment 61: The system of embodiment 36 wherein at least one of the first processing module and the second processing module is configured to send transaction information to a point of sale terminal, which forwards the transaction information to a payment network.

Embodiment 62: The system of embodiment 36 wherein at least one of the first processing module and the second processing module is configured to send transaction directly to a payment network.

Embodiment 63: The system of embodiment 36 wherein the electronic transaction comprises a payment or non-payment transaction.

Embodiment 64: The system of embodiment 36 wherein the electronic transaction comprises at least one of: a payment or purchase; a credit transaction; a debit transaction; a prepaid transaction; a deposit; a withdrawal; a money transfer; a transaction involving a loyalty program; a transaction involving a rewards program; and a transaction involving a diet, health, or fitness program.

Embodiment 65: A computer program product for various financial and non-financial incentives to drive the use of merchant-preferred payment and non-payment options at the time of performing an electronic transaction, the computer program product comprising: a non-transitory computer readable storage medium having computer readable code embodied therewith, the computer readable code comprising: computer readable program code configured for: at a time prior to completion of an electronic transaction between a customer and a merchant: determining a first total and a second total associated with the electronic transaction, wherein the first total is associated with a first transaction option having a first set of incentives and wherein the second total is associated with a second transaction option having either no incentives or a second set of incentives different from the first set of incentives, wherein each transaction option comprises one or more payment and/or non-payment options; dynamically determining, by a backend server, an order for presenting the first total and the second total to the customer; and presenting the first total and the second total to the customer in the dynamically determined order for selection by the customer, wherein the electronic transaction will be completed using the transaction option associated with the total that is selected by the customer.

1-30. (canceled)

31. A system for dynamically presenting various financial and non-financial incentives to drive the use of merchant-preferred payment and non-payment options at the time of performing an electronic transaction, the system comprising:
a database for storing and maintaining customer information;
one or more processors; and
memory storing instructions executable by the one or more processors, whereby the system is operable to, at a time prior to completion of the electronic transaction between a customer and a merchant:
determine a first set of incentives and a second set of incentives associated with the electronic transaction, wherein the first set of incentives is associated with a first transaction option and wherein the second set of incentives is associated with a second transaction option, wherein each transaction option comprises one or more payment or non-payment options;
determine, based on the first set of incentives, first information to be presented to the customer and determining, based on the second set of incentives, second information to be presented to the customer, the first and second information comprising at least one of: incentives, discounted totals, and undiscounted totals;
dynamically determine an order for presenting the first and second information to the customer;
present the first and second information to the customer in the dynamically determined order for selection by the customer;
determine that the customer has selected one of the first and second information; and
complete the electronic transaction using a transaction option associated with the information that is selected by the customer.

32. The system of claim 31 wherein the order is determined based at least in part on preferences provided by the merchant.

33. The system of claim 31 wherein at least one of the first set of incentives, the second set of incentives, the first information, and the second information is determined by a backend server and presented to the customer.

34. (canceled)

35. The system of claim 31 wherein at least one of the first set of incentives, the second set of incentives, the first information, and the second information is determined by a first backend server and transmitted to a second backend server and wherein the first and second information is transmitted from the second backend server to the customer.

36. The system of claim 35 wherein the first backend server is a merchant backend server that maintains merchant-centric information and wherein the second backend server is a mobile backend server that maintains customer-centric information.

37. The system of claim 31 wherein the first information and the second information are presented to the customer via a mobile device of the customer and/or via a device provided by the merchant.

38. (canceled)

39. (canceled)

40. The system of claim 31 wherein at least one of the first and second sets of incentives includes at least one of:
a discount based on a payment option used to complete the transaction;
a discount based on a loyalty card used to complete the transaction;
a discount based on a promotion available to the customer based on personalized information associated with the customer;
a discount based on a loyalty level of the customer; and
a discount for each stock keeping unit (SKU) of individual products comprising the total.

41-43. (canceled)

44. The system of claim 40 wherein the personalized information includes a location of the customer.

45. The system of claim 44 wherein the location of the customer includes one of: a mall level, a merchant level, and an aisle level.

46. The system of claim 40 wherein the personalized information is received from a mobile device of the customer or from a point of sale terminal with which the customer interacts.

47. (canceled)

48. (canceled)

49. The system of claim 31 wherein dynamically determining the order includes receiving an order determined by a merchant during checkout.

50. The system of claim 31 wherein at least one of the transaction options identifies a type of payment instrument to be used.

51. (canceled)

52. (canceled)

53. The system of claim 31 wherein the electronic transaction comprises a mobile electronic transaction involving a mobile device of the customer.

54. The system of claim 53 wherein the mobile electronic transaction involves an interaction between the mobile device and a physical point of sale (POS) terminal or eCommerce site.

55. The system of claim 54 wherein the mobile device is digitally connected to the POS terminal or eCommerce site through the use of a quick response (QR) Code, a near field communication (NFC) connection, a Bluetooth or Bluetooth Low Energy (BLE) connection, WiFi, sound, numeric, or alphanumeric code that provides to the mobile device information that identifies the POS terminal or eCommerce site and which the mobile device uses to establish the digital connection to the POS terminal or eCommerce site.

56. (canceled)

57. The system of claim 53 wherein the mobile device determines information about an item, a location, or the merchant through the use of a quick response (QR) Code, a near field communication (NFC) connection, a Bluetooth or Bluetooth Low Energy (BLE) connection, WiFi, sound, numeric, or alphanumeric code.

58. (canceled)

59. The system of claim 31 wherein, subsequent to selection by the customer and prior to completing the electronic transaction, the system at least one of:
presents the customer with additional options;
requests that the customer reconsider the customer's selection of a non-merchant-preferred payment or non-payment option; and
rewards the customer for selecting the merchant-preferred payment or non-payment option.

60. The system of claim 59 wherein presenting the customer with the additional options includes presenting at least one of:
an option to redeem rewards or loyalty points;
an option to view one or more coupons;
an option to take advantage of a discount or special offer;
an option to apply and instantly receive a payment account;
an option to apply and instantly receive a payment or non-payment digital card;
an option to choose installment plan payment option;
an option to perform an automated clearing house (ACH) transaction;
additional products for the customer to consider; and
alternatives to a product that the customer is about to purchase.

61. A non-transitory computer readable medium storing software instructions that when executed by one or more processors of a system for dynamically presenting various financial and non-financial incentives to drive the use of merchant-preferred payment and non-payment options at the time of performing an electronic transaction, cause the system to, at a time prior to completion of the electronic transaction between a customer and a merchant:
determine a first set of incentives and a second set of incentives associated with the electronic transaction, wherein the first set of incentives is associated with a first transaction option and wherein the second set of incentives is associated with a second transaction option, wherein each transaction option comprises one or more payment or non-payment options;
determine, based on the first set of incentives, first information to be presented to the customer and determine, based on the second set of incentives, second information to be presented to the customer, the first and second information comprising at least one of: incentives, discounted totals, and undiscounted totals;
dynamically determine an order for presenting the first and second information to the customer;
present the first and second information to the customer in the dynamically determined order for selection by the customer;
determine that the customer has selected one of the first and second information; and
complete the electronic transaction using a transaction option associated with the information that is selected by the customer.

62. A method for dynamically presenting various financial and non-financial incentives to drive the use of merchant-preferred payment and non-payment options at the time of performing an electronic transaction, the method comprising:
at a time prior to completion of the electronic transaction between a customer and a merchant:
determining a first set of incentives and a second set of incentives associated with the electronic transaction, wherein the first set of incentives is associated with a first transaction option and wherein the second set of incentives is associated with a second transaction option, wherein each transaction option comprises one or more payment or non-payment options;
determining, based on the first set of incentives, first information to be presented to the customer and determining, based on the second set of incentives, second information to be presented to the customer, the first and second information comprising at least one of: incentives, discounted totals, and undiscounted totals;
dynamically determining an order for presenting the first and second information to the customer;
presenting the first and second information to the customer in the dynamically determined order for selection by the customer;
determining that the customer has selected one of the first and second information; and
completing the electronic transaction using a transaction option associated with the information that is selected by the customer.
